(19) United States
(12) Patent Application Publication
(10) Pub. No.: US 2021/0197528 A1
(43) Pub. Date: Jul. 1, 2021

(54) LAMINATE WEB

(71) Applicant: INNOVIA FILMS LIMITED, Cumbria (GB)

(72) Inventor: Stephen LANGSTAFF, Cumbria (GB)

(73) Assignee: Innovia Films Limited, Cumbria (GB)

(21) Appl. No.: 15/777,370

(22) PCT Filed: Feb. 10, 2017
(86) PCT No.: PCT/GB2017/050339

§ 371 Date: May 18, 2018

(30) Foreign Application Priority Data
Feb. 11, 2016 (GB) 1602471.3

(51) Int. Cl. B32B 15/085; B32B 27/32; B32B 7/12; B32B 15/18; B32B 27/20

(52) U.S. Cl. CPC B32B 15/085; B32B 2307/536; B32B 7/12; B32B 15/18; B32B 27/20; B32B 2307/4026; B32B 2307/518; B32B 2255/10; B32B 2255/26; B32B 2307/4023; B32B 2451/00; B32B 2607/02; B32B 2307/412; B32B 2307/41; B32B 2264/1022; B32B 27/32

(57) ABSTRACT

The present invention provides a metal filmic laminate web comprising a web of self-supporting metal substrate; a printed filmic web comprising machine and transverse directions and being adhered to the metal substrate by means of an adhesive layer between the printed filmic web and the web of self-supporting metal substrate, the printed filmic web comprising a filmic substrate and digitally printed matter provided as a sequential array comprising at least a pair of non-repetitive images on the web; a first image being digitally printed on a machine direction defined first portion of the web and a second image being separately digitally printed on a machine direction defined second portion of the web, the first and second portions being adjacent or neighbouring each other in a machine direction on the web and the first image being different from the second image.

The present invention relates to a metal filmic laminate web having a web of self-supporting metal substrate and a printed filmic web adhered thereto.

Laminate structures having a metal substrate and a filmic layer are used in a wide variety of applications.

For certain applications, the metal substrate may be non-self-supporting. For example, WO0114139 describes a flexible, foil-shaped packaging material which is provided with an at least partially applied material layer in the form of a pattern consisting of images and/or signs.

EP1586447 describes a roll-to-roll lamination process for flexible webs comprising: coating of at least one side of a flexible web with a film forming adhesive; and contacting the adhesive side(s) of the flexible web to a flexible web and/or on a transport roller while the combined webs are touching the transport roller from one side on a length of more than 5 mm without being further pressurised.

Alternatively, for certain applications, the metal substrate may be more rigid. For example, it is known to use laminate structures having a metal substrate and a filmic layer in household articles and industrial articles. Often the filmic layer forms the outer layer of such articles, and may be printed to improve the aesthetic appeal of the articles.

WO2008067812 describes a method of making laminated metal plates for panels, cabinets and the like, wherein a coiled metal plate is uncoiled and passed through rollers at the same time as a film is uncoiled and likewise passed through rollers to be joined with glue to form a laminate. Prior to the joining, the film is passed through a printer which applies a motif. The laminated metal plate may then be cut to an object, which may be shaped such that the punched object constitutes a panel or the like with a film coating everywhere on the surface.

WO03020520 describes a method for producing a decoration member, in which a pattern sheet is made by printing a transparent resin sheet with colouring ink and forming a coloured pattern part. The pattern sheet is then turned over such that the coloured pattern part touches the surface of a base member and laid on the base member. Subsequently, the pattern sheet is pressed against the base member and the coloured pattern part is heated and bonded thermally to the surface of the base member and the pattern sheet is bonded to the base member.

JP2000103881 describes a thermoplastic resin film which, when laminated to a metal sheet, exhibits an internal stress of 0.25 kg/mm² or lower at 85 to 300° C. The film is preferably prepared from a mixture of a polyester with a polyester-polyether block copolymer, the polyester being one of which the acid component contains at least 70 wt. % terephthalic acid and the block copolymer being contained in an amount of 0.1 to 10 wt. % in terms of polyether.

However, the laminate structures of the prior art have numerous limitations associated therewith. For example, the print is provided on the laminate structure as a sequential array of repeat images, and these are often limited in terms of the maximum size of each repeat image.

According to a first aspect of the present invention there is provided a metal filmic laminate web comprising a web of self-supporting metal substrate; a printed filmic web comprising machine and transverse directions and being adhered to the metal substrate by means of an adhesive layer between the printed filmic web and the web of self-supporting metal substrate, the printed filmic web comprising a filmic substrate and digitally printed matter provided as a sequential array comprising at least a pair of non-repetitive images on the web; a first image being digitally printed on a machine direction defined first portion of the web and a second image being separately digitally printed on a machine direction defined second portion of the web, the first and second portions being adjacent or neighbouring each other in a machine direction on the web and the first image being different from the second image.

Advantageously, the metal filmic laminate web of the present invention can be manufactured without carrying repeat images. This may be particularly desirable where the metal filmic laminate web is to be used in a large article e.g. wall cladding. For example, if the metal filmic laminate web is to be printed with a natural effect e.g. a wood effect, it can be printed on large scale without any repeat images, thus, making the effect more realistic. It may also be particularly desirable where the metal filmic laminate web is used to carry bespoke/unique designs for smaller articles.

In addition, the metal filmic laminate web of the present invention may carry a plurality of ‘small-run’ designs. What we mean by a ‘small-run’ design is a plurality of repeat images which has a total length less than the length of the reel of filmic substrate onto which it is printed. At the end of a first small-run design, a second small-run design can be started on the same reel of filmic substrate. The repeat images of the second small-run design may be different from those of the first small-run design. In this case, the at least a pair of non-repetitive images in the sequential array may comprise a last machine direction image of a first repeating array of images and first machine direction image of a second repeating array of images following the first array on the web.

Importantly, it has been found that on a single reel of filmic substrate, different images can be printed—with or without repeats. A reel of filmic substrate may have a length of at least about 1000 m, at least about 5000 m, at least about 10,000 m, at least about 20,000 m, or at least about 30,000 m. Consequently, a single reel of filmic substrate may comprise a multitude of sequential images, each image being different from its neighbouring image and/or images. Alternatively, a single web of film may comprise a multitude of arrays of repeating images, the images of one array being different from the images of its neighbouring array and/or arrays.

The term ‘web of self-supporting metal substrate’ preferably means a web of metal substrate which does not require support from other layers in the laminate web to maintain its shape. For the avoidance of doubt, the term ‘web of self-supporting metal substrate’ does not include thin-layer metal coatings, for example those with a thickness of less than 100 μm, which may be applied by vapour deposition or the like.

The web of self-supporting metal substrate may comprise any suitable metal and/or metal alloy. For example, the web of self-supporting metal substrate may comprise aluminium, copper, iron, nickel, tin, titanium, zinc and/or metal alloys thereof. The web of self-supporting metal substrate may comprise a metal alloy such as steel and/or brass.

Preferably, the web of self-supporting metal substrate comprises steel, aluminium or an alloy thereof. The steel may be untreated steel, rolled steel, primed steel, painted steel, electro-treated steel and/or galvanised steel. ‘Primed steel’ may refer to steel which has been primed with a polymeric coating, for example polyethylene terephthalate (PET).

The aluminium may be primed aluminium or painted aluminium, for example. ‘Primed aluminium’ may refer to aluminium which has been primed with a polymeric coating, for example PET.

The thickness of the web of self-supporting metal substrate may be from about 100 μm to about 10 mm. Preferably, the thickness of the web of self-supporting metal substrate is from about 200 μm to about 4 mm, from about 300 μm to about 3 mm, from about 400 μm to about 2 mm, or from about 0.5 mm to about 1 mm.

The printed filmic web comprises machine and transverse directions.

The machine direction (MD) may be defined as the direction in which the web passes or has been passed through a production machine. The transverse direction (TD) may be defined as being normal to the MD.

The printed filmic web may have a thickness of from about 1 μm to about 200 μm; from about 10 μm to about 70 μm; from about 20 μm to about 60 μm; or from about 30 μm to about 50 μm.

The printed filmic web comprises a filmic substrate.

The filmic substrate may comprise one or more polyolefins, for example polyethylene, polypropylene, polybutylene and/or copolymers (random or block) thereof and/or other known polyolefins. Preferably, the filmic substrate comprises polypropylene. More preferably, the filmic substrate comprises cast polypropylene or biaxially oriented polypropylene (BOPP).

Additionally or alternatively, the filmic substrate may comprise a biopolymer, for example cellulose or derivatives thereof, carbohydrate-based polymers or lactic acid based polymers e.g. polylactic acid; polyethylene furanoate (PEF); a polyurethane; a polyvinylhalide e.g. polyvinyl chloride (PVC), a polystyrene; a polyester e.g. polyethylene terephthalate; a polyamide; a polycarbonate; an acetate; and/or mixtures or blends thereof.

The filmic substrate may comprise a single layer or multiple layers. Where the filmic substrate comprises multiple layers, it may include a core layer and one or more skin layers. The core and/or skin layer(s) may comprise any of the materials previously listed as suitable for the filmic substrate.

The filmic substrate may be made by any process known in the art, including, but not limited to, cast sheet, cast film and blown film. The film may be prepared as a balanced film using substantially equal machine direction (MD) and transverse direction (TD) stretch ratios. Alternatively, the film may be prepared as an unbalanced film, where the film is significantly more oriented in one direction (MD or TD).

Sequential stretching can be used to form the filmic substrate, for example heated rollers may effect stretching of the film in the MD and an oven may be used thereafter to effect stretching in the TD. Alternatively, simultaneous stretching, for example using the so-called bubble process (operated by Innovia Films Limited, Wigton UK) or simultaneous draw Stenter stretching, may be used.

Unstretched films may also be used.

The filmic substrate may be transparent or at least translucent.

Alternatively, the filmic substrate may be opaque. Where an opaque film is required, a pigment may be provided in the filmic substrate. Where a white-coloured film is required, the pigment used may be titanium dioxide.

The filmic substrate may have a thickness of from about 1 μm to about 200 μm; from about 10 μm to about 70 μm; from about 20 μm to about 60 μm; or from about 30 μm to about 50 μm. For example, the filmic substrate may have a thickness of about 35 μm.

The printed filmic web may additionally comprise a printable coating.

The printable coating may be provided on one of the major surfaces of the filmic substrate.

The printable coating may comprise a polymeric binder and an ethylenically unsaturated compound dispersed with or bonded to the polymeric binder.

Preferably, the polymeric binder is a water dispersible polymer. By way of non-limiting example, the polymeric binder may be selected from water dispersible acrylics, acrylates, urethanes, urethane acrylates, styrene butadiene/maleic anhydride copolymers and/or mixtures thereof. Alternatively, solvent based polymeric binders may be used.

The polymeric binder may be present in the printable coating in an amount of from about 10% to about 98%, from about 60% to about 95%, or from about 74% to about 92% by weight of the printable coating (these percentages are dry weight based).

The ethylenically unsaturated compound may be provided as a distinct component in the printable coating. Additionally or alternatively, the ethylenically unsaturated compound may be provided as part of the polymeric binder itself, for example as a functional side chain of the polymeric binder.

Preferably, the ethylenically unsaturated compound contains 1 to 10 double bonds per molecule and still more preferably 2 to 5 double bonds per molecule (or per functional group in the event that the compound is provided as a pendant side chain from, or otherwise as part of, the polymeric binder e.g. a water dispersible polymeric binder).

Suitable ethylenically unsaturated compounds include the ester derivatives of α, β-ethylenically unsaturated acids, such as acrylic or methacrylic acids, itaconic or citraconic acids, maleic or fumaric acids, with polyols or alkoxylated polyols. Other suitable ethylenically unsaturated compounds include derivatives of isocyanate prepolymers or oligomers reacted with ethylenically unsaturated alcohols and ethoxylated variants thereof, such as Desmodur™ (Bayer) trifunctional isocyanate reacted with hydroxyl ethyl methacrylate. In other words, ethylenically unsaturated compounds used in accordance with the present invention may comprise one or more urethane linkages in addition to, or instead of, one or more ester linkages.

Examples of ethylenically unsaturated compounds which can be used according to the invention include polyfunctional acrylates such as difunctional acrylates, for example 1,4-butane diol acrylate, 1,6-hexane diol diacrylate, neopentyl glycol diacrylate, triethylene glycol diacrylate, polyethylene glycol diacrylate, tripropylene glycol diacrylate, 2,2-dionol diacrylate, bisphenol A diacrylate; trifunctional acrylates, for example pentaerythritol triacrylate, trimethylolpropane triacrylate; and tetrafunctional acrylates. It is to be understood that the methacrylate derivatives corresponding to these acrylate derivatives could also be used. Polyallyl derivatives such as tetraallyloxyethane are also suitable. Suitable material in this connection are commercially available under the trade name Ebecryl™.

The amount of the ethylenically unsaturated compound may be from about 2% to about 90%, from about 2% to about 15%, or from about 2% to about 10% by weight of the polymeric binder.

Advantageously, the ethylenically unsaturated compound is able to form a covalent bond with digitally printed matter.

Optionally, the printable coating further comprises a crosslinker. The crosslinker is capable of binding the printable coating to the filmic substrate and/or to a primer layer which may be situated between the printable coating and the filmic substrate. Suitable crosslinkers include carbodiimide and aziridine crosslinkers, and crosslinkers disclosed in WO 02/31016, for example. Where these types of crosslinker are used, a primer layer i.e. a separate layer which binds the filmic substrate to the printable coating, may not be required.

Alternatively, the crosslinker may be a coordinating metal ligand which can form stable coordinated structures with carboxy or carbonyl functionality. For example, Ammonium zirconium carbonate (stabilised or not).

The crosslinker may be present in the printable coating in an amount of from about 1% to about 10%, from about 1% to about 5%, or from about 2% to about 5% by weight of the polymeric binder.

The printed filmic web may further comprise a primer layer. The primer layer, where present, is preferably provided between the filmic substrate and the printable coating to aid binding therebetween.

The primer layer may comprise polyethylene imine or polyurethane acrylate primers crosslinked by isocyanate, epoxy, aziridine or silane derivatives.

Examples of printable coatings as outlined above are described in WO9727064 and WO2010067111, and are incorporated herein by reference. There are many other kinds of printable coating known in the art which would be suitable.

The printed filmic web may additionally comprise a coating for improving adhesion between the printed filmic web and the adhesive layer (subsequently referred to as the ‘adhesion-promoting coating’). Such a coating may be provided on one of the major surfaces of the filmic substrate.

The adhesion-promoting coating may comprise the same or different materials from those described above in connection with the printable coating.

Where the printed filmic web comprises both a printable coating and an adhesion-promoting coating, the printed filmic web can be described as a two-side coated film. In this scenario, the printable coating and the adhesion-promoting coating are provided on opposing surfaces of the filmic substrate.

The printed filmic web comprises digitally printed matter provided as a sequential array comprising at least a pair of non-repetitive images on the web. A first image is digitally printed on a machine direction defined first portion of the printed filmic web and a second image being separately digitally printed on a machine direction defined second portion of the printed filmic web, the first and second portions being adjacent or neighbouring each other in a machine direction on the printed filmic web and the first image being different from the second image.

The sequential array comprising at least a pair of non-repetitive images may comprise any number of different images. Computer software may be utilised to generate an infinite number of different images to form the sequential array.

The digitally printed matter may be applied using any known digital printing technique, for example UV ink-jet printing, water-based ink-jet printing, solvent-based ink-jet printing, digital laser printing, dry toner technology, wet toner technology, or digital offset printing for example HP™ Indigo digital printing.

The digitally printed matter may be applied directly onto the filmic substrate. However, where a printable coating is present in the printed filmic web, the digitally printed matter is preferably applied directly onto the printable coating.

It may be desirable for the printed filmic web to have a certain degree of elasticity or conformability to curved or cornered surfaces.

When the metal filmic laminate web is used in the manufacture of an article it will usually be subject to some form of deformation/distortion. By using a printed filmic web with a certain degree of elasticity or conformability to curved or cornered surfaces, the printed filmic web will be able to deform/distort during manufacture of the article, without cracks or other forms of visual defect appearing.

It may be desirable to apply the digitally printed matter to the filmic substrate as a distorted image which normalises when the metal filmic laminate web is formed into an article.

Computer software may be used which is capable of predicting the level of distortion required in an image, so that the image in the final article is normalised.

Accordingly, the invention provides a metal filmic laminate web in accordance with the above, wherein an image is optically varied on a portion of the filmic substrate which is intended to receive a curve, fold or bend in a finished article incorporating the metal filmic laminate web such that the image is distorted on the web but normalised on the curve, fold or bend of the finished article.

An over-lacquer may be provided over the digitally printed matter. The over-lacquer may help to protect the digitally printed matter from becoming chipped, scratched or otherwise damaged, and/or discoloured.

Any suitable over-lacquer may be used. For example, the over-lacquer may be acrylate-based. The over-lacquer may be water, solvent and/or UV curable. A specific example of a UV curable over-lacquer is Sun Cure®.

Importantly, the over-lacquer must have a high level of hardness. The hardness of the over-lacquer can be defined in terms of pencil hardness according to standard test method ASTM D3363. For example, the over-lacquer may have a hardness of at least 1H. Preferably, the over-lacquer has a hardness of at least 2H. More preferably, the over-lacquer has a hardness of at least 3H.

The printed filmic web and/or the over-lacquer may comprise one or more additives selected from: antistatic additives, anti-block additives, slip-promoting additives, UV blockers, UV stabilisers, dyes, pigments, colourants, lubricants, antioxidants, surface-active agents, stiffening aids, gloss improvers, prodegradants, tack reducing additives, particulate materials, additives to reduce the coefficient of friction, sealability additives, and additives to further improve ink adhesion and/or printability.

Preferably, the printed filmic web and/or the over-lacquer comprise one or more UV blockers. The one or more UV blockers may be selected from non-aggregated inorganic materials and/or organic materials.

Examples of suitable non-aggregated inorganic materials include mineral oxides, such as metal oxides, for example non-aggregated zinc and/or titanium oxides. Examples of suitable organic materials include triazines, hindered amines, oxanilides, cyanoacrylates, benzotriazoles and/or benzophenones.

Advantageously, the one or more UV blockers help to prevent UV degradation, for example colour fading, of the digitally printed matter. Thus, it is important that the one or more UV blockers are located in a layer external to the digitally printed matter e.g. in the over-lacquer or the filmic substrate.

The printed filmic web is adhered to the web of self-supporting metal substrate by means of an adhesive layer between the printed filmic web and the web of self-supporting metal substrate.

The strength of adhesion between the printed filmic web and the web of self-supporting metal substrate must be sufficient for the metal filmic laminate web to be fit for purpose. Preferably the metal filmic laminate web achieves a ‘pass’ result in the Erichsen ‘Cross Cutter’ adhesion test according to standard test method ISO 1520:2006.

The adhesive layer may comprise any suitable adhesive, for example a solvent-based adhesive, a hot melt adhesive or a reactive extrusion adhesive.

The solvent-based adhesive and/or the hot melt adhesive may comprise maleic anhydride. Alternatively, the solvent-based adhesive may comprise an isocyanate or a di-isocyanate.

Alternatively, the hot melt adhesive may comprise ethylene acrylic acid (EAA) or a polyurethane.

The reactive extrusion adhesive may comprise maleic anhydride grafted polyolefin. For example, the reactive extrusion adhesive may comprise maleic anhydride grafted polypropylene or maleic anhydride grafted polyethylene.

The printed filmic web may be adhered to the web of self-supporting metal substrate in an orientation which means the digitally printed matter is not viewed through the filmic substrate, for example the digitally printed matter is directly viewed or viewed through an over-lacquer.

Alternatively, the printed filmic web may be adhered to the web of self-supporting metal substrate in an orientation which means the digitally printed matter is viewed through the filmic substrate. In this scenario, the printed filmic web may be referred to as being ‘reverse printed’.

It may be preferable to pre-treat one or both major surfaces of the filmic substrate with a view to improving the wetting and/or adhesiveness of the filmic substrate. For example, one or both major surfaces of the filmic substrate may be pre-treated using corona discharge, flame treatment, plasma treatment such as modified dielectric barrier discharge (MADBD) treatment, and/or oxidising chemical treatment.

Where the digitally printed matter is applied directly onto a major surface of the filmic substrate, pre-treatment of that surface may improve the adhesion of the digitally printed matter to the filmic substrate.

Where a major surface of the filmic substrate contacts the adhesive layer, pre-treatment of that surface may improve adhesion between the printed filmic web and the adhesive layer. Consequently, adhesion between the printed filmic web and the web of self-supporting metal substrate may be improved.

Where a major surface of the filmic substrate is coated with a printable coating, pre-treatment of that surface may improve the adhesion between the filmic substrate and the printable coating. This may be particularly desirable when no primer layer is used.

According to a second aspect of the present invention there is provided a metal filmic laminate sheet severed from the metal filmic laminate web in a transverse direction of the web at a junction between the first and second portions.

A plurality of metal filmic laminate sheets may be severed from the metal filmic laminate web in the manner described above. Each metal filmic laminate sheet may carry a different image.

The metal filmic laminate sheet may be formed into an article, for example a household article or an industrial article. More specifically, the metal filmic laminate sheet may be formed into cladding, for example the interior or exterior cladding for wall(s) of a building; a door; a ceiling panel; and/or flooring. Alternatively, the metal filmic laminate sheet may be formed into the outer housing of a household article, for example a washing machine, tumble dryer, fridge, freezer or dishwasher.

A plurality of the articles may be arranged to form a coherent image from the digitally printed matter on each article.

Also provided in accordance with the invention is a plurality of arranged articles as hereinbefore described, wherein a first article severed from the metal filmic laminate in the transverse direction of the web at the junction between the first and second portions is arranged side by side with a second article severed from the metal filmic laminate in the transverse direction of the web at the junction between the first and second portions, wherein an image printed on the first article corresponds with an image printed on the first portion of the web and an image printed on the second article corresponds with an image printed on the second portion of the web, and wherein side by side the image printed on the first article forms together with the image printed on the second article the coherent image.

According to a third aspect of the present invention there is provided a process for manufacturing a metal filmic laminate web comprising:
providing a filmic web comprising a filmic substrate, the filmic web comprising machine and transverse directions;
digitally printing the filmic web with digitally printed matter provided as a sequential array comprising at least a pair of non-repetitive images on the web, a first image being digitally printed on a machine direction defined first portion of the web and a second image being separately digitally printed on a machine direction defined second portion of the web, the first and second portions being adjacent or neighbouring each other in a machine direction on the web and the first image being different from the second image;
applying an adhesive layer onto a web of self-supporting metal substrate; and
adhering the printed filmic web onto the web of self-supporting metal substrate by means of the adhesive layer.

The process may further comprise severing a sheet from the metal filmic laminate web in a transverse direction of the web at a junction between the first and second portions.

The process may further comprise forming the metallic filmic laminate sheet into an article.

For the avoidance of doubt, all features relating to the first aspect of the invention also apply, where appropriate, to the second and third aspects of the invention and vice versa.

The invention will now be more particularly described with reference to the following figures and examples.

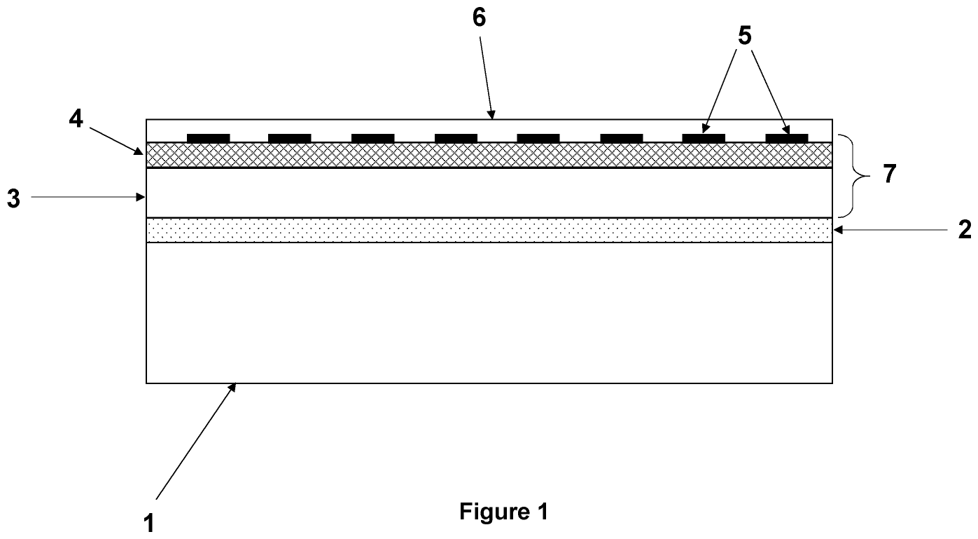

FIG. 1: a schematic diagram of a metal filmic laminate web according to an embodiment of the present invention

FIG. 1 shows a schematic diagram of a metal filmic laminate web. The metal filmic laminate web comprises a web of self-supporting metal substrate 1, an adhesive layer 2, a printed filmic web 7 having machine and transverse directions, and an over-lacquer 6. The printed filmic web 7 comprises a filmic substrate 3, a printable coating 4 and digitally printed matter 5.

The adhesive layer 2 is located between and in contact with one of the major surfaces of the filmic substrate 3 and the web of self-supporting metal substrate 1, and adheres the printed filmic web 7 to the web of self-supporting metal substrate 1.

The printable coating 4 is provided on the other major surface of the filmic substrate 3 (away from the adhesive layer 2). The digitally printed matter 5 is applied directly on the printable coating 4. The over-lacquer 6 is provided over the digitally printed matter 5 to protect it from becoming chipped, scratched or otherwise damaged, and/or discoloured. The over-lacquer 6 comprises one or more UV blockers (not shown) to help prevent UV degradation of the digitally printed matter 5.

### EXAMPLES

A web of white biaxially oriented polypropylene (BOPP) film having a thickness of 35 μm was manufactured by means of a bubble process. An acrylic-based printable coating having a thickness of 1 μm was provided on one of the major surfaces of the BOPP film web.

UV ink-jet printing was used to apply a sequential array of images onto the printable coating of the BOPP film web. A first image was printed on a machine direction defined first portion of the BOPP film web and a second image was separately printed on a machine direction defined second portion of the BOPP film web, the first and second portions being adjacent each other in a machine direction on the web and the first image was different from the second image.

The ink used in the UV ink-jet printing was a UV curable ink having a thickness of 10 μm. A UV curable acrylate over-lacquer was provided over the digitally printed matter at a thickness of 3 μm.

An adhesive layer comprising isocyanate and having a thickness of 40 μm was applied to a web of galvanised steel having a thickness of 500 μm, via roller coating.

The BOPP film web was then laminated to the web of galvanised steel via the adhesive layer.

It was observed that the resulting metal filmic laminate web was suitable for manufacturing an article therefrom, for example external or internal decorative wall claddings.

1. A metal filmic laminate web comprising a web of self-supporting metal substrate; a printed filmic web comprising machine and transverse directions and being adhered to the metal substrate by means of an adhesive layer between the printed filmic web and the web of self-supporting metal substrate, the printed filmic web comprising a filmic substrate and digitally printed matter provided as a sequential array comprising at least a pair of non-repetitive images on the web; a first image being digitally printed on a machine direction defined first portion of the web and a second image being separately digitally printed on a machine direction defined second portion of the web, the first and second portions being adjacent or neighbouring each other in a machine direction on the web and the first image being different from the second image.

2. A metal filmic laminate web according to claim 1, wherein the web of self-supporting metal substrate comprises steel, aluminium or an alloy thereof.

3. A metal filmic laminate web according to claim 1 or claim 2, wherein the thickness of the web of self-supporting metal substrate is from about 100 μm to about 10 mm, from about 200 μm to about 4 mm, from about 300 μm to about 3 mm, from about 400 μm to about 2 mm, or from about 0.5 mm to about 1 mm.

4. A metal filmic laminate web according to any one of claims 1 to 3, wherein the filmic substrate comprises one or more polyolefins; a biopolymer; polyethylene furanoate; a polyurethane; a polyvinylhalide; a polystyrene; a polyester; a polyamide; a polycarbonate; an acetate; and/or mixtures or blends thereof.

5. A metal filmic laminate web according to any one of claims 1 to 4, wherein the filmic substrate comprises polypropylene, optionally cast polypropylene or biaxially oriented polypropylene.

6. A metal filmic laminate web according to any one of claims 1 to 5, wherein the filmic substrate is transparent.

7. A metal filmic laminate web according to any one of claims 1 to 5, wherein the filmic substrate is opaque.

8. A metal filmic laminate web according to claim 7, wherein the filmic substrate comprises titanium dioxide pigment.

9. A metal filmic laminate web according to any one of claims 1 to 8, wherein the printed filmic web additionally comprises a printable coating.

10. A metal filmic laminate web according to claim 9, wherein the printable coating comprises a polymeric binder and an ethylenically unsaturated compound dispersed with or bonded to the polymeric binder, and optionally comprises a crosslinker.

11. A metal filmic laminate web according to any one of claims 1 to 10, wherein the digitally printed matter is applied using UV ink-jet printing, water-based ink-jet printing, solvent-based ink-jet printing, digital laser printing, dry toner technology, wet toner technology, or digital offset printing for example HP™ Indigo digital printing.

12. A metal filmic laminate web according to any one of claims 1 to 11, wherein an over-lacquer is provided over the digitally printed matter.

13. A metal filmic laminate web according to claim 12, wherein the over-lacquer has a hardness of at least 1H, at least 2H, or at least 3H.

14. A metal filmic laminate web according to any one of claims 1 to 13, wherein the printed filmic web and/or the over-lacquer comprise one or more UV blockers.

15. A metal filmic laminate web according to claim 14, wherein the one or more UV blockers are selected from non-aggregated inorganic materials and/or organic materials.

16. A metal filmic laminate web according to claim 15, wherein the non-aggregated inorganic material is selected from non-aggregated zinc and/or titanium oxides.

17. A metal filmic laminate web according to claim 15 or claim 16, wherein the organic material is selected from triazines, hindered amines, oxanilides, cyanoacrylates, benzotriazoles and/or benzophenones.

18. A metal filmic laminate according to any one of claims 1 to 17, wherein the adhesive layer comprises a solvent-based adhesive, a hot melt adhesive or a reactive extrusion adhesive.

19. A metal filmic laminate according to any one of claims 1 to 18, wherein one or both major surfaces of the filmic substrate is pre-treated using corona discharge, flame treatment, plasma treatment such as modified dielectric barrier discharge treatment, and/or oxidising chemical treatment.

20. A metal filmic laminate sheet severed from the metal filmic laminate according to any one of claims 1 to 19 in a transverse direction of the web at a junction between the first and second portions.

21. An article formed from the laminate sheet according to claim 20.

22. A plurality of articles according to claim 21 arranged to form a coherent image from the digitally printed matter on each article.

23. A plurality of arranged articles according to claim 22, wherein a first article severed from the metal filmic laminate in the transverse direction of the web at the junction between the first and second portions is arranged side by side with a second article severed from the metal filmic laminate in the transverse direction of the web at the junction between the first and second portions, wherein an image printed on the first article corresponds with an image printed on the first portion of the web and an image printed on the second article corresponds with an image printed on the second portion of the web, and wherein side by side the image printed on the first article forms together with the image printed on the second article the coherent image.

24. A process for manufacturing a metal filmic laminate web comprising:
providing a filmic web comprising a filmic substrate, the filmic web comprising machine and transverse directions;
digitally printing the filmic web with digitally printed matter provided as a sequential array comprising at least a pair of non-repetitive images on the web, a first image being digitally printed on a machine direction defined first portion of the web and a second image being separately digitally printed on a machine direction defined second portion of the web, the first and second portions being adjacent or neighbouring each other in a machine direction on the web and the first image being different from the second image;
applying an adhesive layer onto a web of self-supporting metal substrate; and
adhering the printed filmic web onto the web of self-supporting metal substrate by means of the adhesive layer.

25. A process according to claim 24 further comprising severing a sheet from the metal filmic laminate web in a transverse direction of the web at a junction between the first and second portions.

26. A process according to claim 25 further comprising forming the metallic filmic laminate sheet into an article.
